(19) United States
(12) Patent Application Publication
(10) Pub. No.: US 2021/0390581 A1
(43) Pub. Date: Dec. 16, 2021

(54) TECHNOLOGY FOR ANALYZING VEHICLE OCCUPANT DATA TO IMPROVE THE DRIVING EXPERIENCE

(71) Applicant: STATE FARM MUTUAL AUTOMOBILE INSURANCE COMPANY, Bloomington, IL (US)

(72) Inventors: Aaron Scott Chan, Bloomington, IL (US); Kenneth J. Sanchez, San Francisco, CA (US)

(21) Appl. No.: 15/872,320

(22) Filed: Jan. 16, 2018

Related U.S. Application Data
(60) Provisional application No. 62/448,192, filed on Jan. 19, 2017.

(51) Int. Cl. G06Q 30/02; G06K 9/00; G01C 21/36

(52) U.S. Cl. CPC G06Q 30/0266; G06Q 30/0261; G01C 21/3697; G06K 9/00845; G06Q 30/0269

(57) ABSTRACT

Systems and methods for analyzing vehicle occupant data to improve the driving experience are provided. According to certain aspects, image sensor data of a vehicle occupant may be used to determine the emotional state of the vehicle occupant which may be used by businesses in proximity to the vehicle to effectively advertise to the vehicle occupant. An electronic device may be used to display the advertisement of a business in proximity to the vehicle.

### CROSS-REFERENCE TO RELATED APPLICATIONS

This application claims benefit of the filing date of U.S. Provisional Patent Application No. 62/448,192, filed Jan. 19, 2017 and titled “TECHNOLOGY FOR ANALYZING VEHICLE OCCUPANT DATA TO IMPROVE THE DRIVING EXPERIENCE,” the disclosure of which is hereby incorporated by reference in its entirety.

### FIELD

The present disclosure is directed to using driver data to improve the driving experience. More particularly, the present disclosure is directed to systems and methods for using the emotional state of a vehicle occupant along with the location of the vehicle and nearby businesses to effectively advertise to the vehicle occupant.

### BACKGROUND

Individuals have been operating and traveling in vehicles as means of transportation for decades. Generally, individuals experience certain emotional states (e.g., happy, sad, angry, frustrated, etc.) while occupying vehicles, where different stimuli may appease individuals depending on their emotional states. For example, a billboard for a coffee discount may appease an individual who is in a happy mood and on his way to work. For further example, a billboard for a spa may appease an individual who is stressed.

Recently, vehicles have experienced an increased prevalence of electronic devices and sensors capable of sensing and generating data associated with vehicle operation. However, even with this increasing prevalence, there are no existing solutions to effectively provide different stimuli to vehicle occupants based on the location of the vehicle and the vehicle occupant's emotional state. Accordingly, there is an opportunity for systems and methods to leverage sensor data such as image data to determine emotional states of vehicle occupants in order to effectively provide different stimuli to the vehicle occupants based on the determined emotional states.

### SUMMARY

In one aspect, a computer-implemented method in an electronic device for displaying advertising content to an occupant of a vehicle is provided. The method may include receiving image data from at least one image sensor located within the vehicle, the image data depicting the occupant of the vehicle; determining, based on the image data, an emotional state of the vehicle occupant; determining a location of the vehicle; identifying a business in proximity to the location of the vehicle; determining, based on the emotional state of the vehicle occupant, an advertisement associated with the business; and displaying, in a user interface of the electronic device, the advertisement.

In another aspect, a system in an electronic device for displaying advertising content to an occupant of a vehicle is provided. The system may include a memory configured to store non-transitory computer executable instructions, and a processor configured to interface with the memory. The processor may be configured to execute the non-transitory computer executable instructions to cause the processor to receive image data from at least one image sensor located within the vehicle, the image data depicting the occupant of the vehicle; determine, based on the image data, an emotional state of the vehicle occupant; determine a location of the vehicle; identify a business in proximity to the location of the vehicle; determine, based on the emotional state of the vehicle occupant, an advertisement associated with the business; and display, in a user interface of the electronic device, the advertisement.

### BRIEF DESCRIPTION OF THE FIGURES

FIGS. 1A and 1B depict exemplary environments within a vehicle including various components configured to facilitate various functionalities, in accordance with some embodiments.

FIG. 2 depicts an exemplary scenario of a vehicle operating on a street in proximity to various businesses, in accordance with some embodiments.

FIG. 3 depicts an exemplary block diagram of an interconnected wireless communication system connecting a set of vehicles, businesses, and remote servers, in accordance with some embodiments.

FIG. 4 depicts an exemplary signal diagram associated with determining an advertisement for a business in proximity to the vehicle, in accordance with some embodiments.

FIG. 5 depicts a flow diagram associated with determining an advertisement for a business in proximity to a vehicle, in accordance with some embodiments.

FIGS. 6A and 6B depict exemplary user interfaces associated with an advertisement for a business in proximity to a vehicle, in accordance with some embodiments.

FIG. 7 is a block diagram of an exemplary electronic device, in accordance with some embodiments.

### DETAILED DESCRIPTION

The present embodiments may relate to, inter alia, delivering relevant advertisements to a vehicle operator based on a current emotional state of the vehicle operator. Businesses are always advertising to individuals. However, many advertisements are often not relevant to a large percent of individuals because the individuals are in varied emotional states. The systems and methods disclosed herein leverage image and position sensors and the data thereof to determine the emotional states of vehicle occupants as well as the location of a vehicle, and identify businesses and advertisements that are relevant to the determined emotional state of the vehicle occupant and the location of the vehicle.

According to certain aspects, a vehicle may be equipped with one or more image sensors configured to capture image data depicting an occupant of the vehicle. An electronic device may analyze data captured by the image sensors to ascertain characteristics associated with an emotional state of the vehicle occupant. The electronic device may then identify relevant advertisements for businesses in the proximity of the vehicle based on the emotional state of the vehicle occupant.

Additionally, the electronic device may determine, identify, or access certain vehicle occupant data, including various personal information (e.g., gender, age, etc.) and preferences (e.g., likes, dislikes, hobbies, etc.) about the vehicle occupant. The electronic device may also access additional information such as the time of day, day of the week, final destination of the vehicle, etc. The electronic device may account for the personal information, preferences, and/or any available additional information when identifying relevant advertisements for businesses in proximity to the vehicle. Further, the electronic device may display advertisements for a business located in proximity to the vehicle for access and review by the vehicle occupant.

The systems and methods therefore offer numerous benefits. In particular, the systems and methods may provide vehicle occupants with relevant and effective advertisements associated with proximate businesses. As a result, the businesses may experience increased customer traffic and therefore increased sales. Additionally, the systems and methods may improve the emotional state of vehicle occupants, improve the driving experience for the vehicle occupants, and improve road safety. It should be appreciated that other benefits are envisioned.

The systems and methods discussed herein address a challenge that is particular to improving the driving experience. In particular, the challenge relates to a difficulty in providing relevant advertising to vehicle occupants. Conventionally, individuals are provided with advertisements without factoring for an emotional state of the individuals. In contrast, the systems and methods discussed herein identify an emotional state of an individual by analyzing sensor data depicting the individual, and identify an advertisement based on the emotional state of the individual. Further, because the systems and methods employ the collection, compiling, storing, and displaying of data associated with the vehicle and vehicle occupant, the systems and methods are necessarily rooted in computer technology in order to overcome the noted shortcomings that specifically arise in the realm of improving the driving experience.

Similarly, the systems and methods provide improvements in a technical field, namely, electronic advertising. Instead of systems and methods merely being performed by hardware components using basic functions, the systems and methods employ complex steps that go beyond the mere concept of simply retrieving and combining data using a computer. In particular, the hardware components capture image sensor data, analyze the image sensor data, determine the emotional state of the vehicle occupant based on the analysis of the image sensor data, determine businesses in proximity to the vehicle, and present advertisements from the businesses in proximity to the vehicle based on the emotional state of the vehicle occupant. This combination of elements further imposes meaningful limits in that the operations are applied to improve electronic advertising by associating multiple types of vehicle and vehicle occupant data as well as data from local businesses in a meaningful and effective way.

According to implementations, the systems and methods may support dynamic, real-time, or near real-time analysis of any captured, received, and/or detected data. In particular, the electronic device may receive data about the emotional state of the vehicle occupant in real-time or near-real-time, and may receive and display data from businesses in proximity to the vehicle in real-time or near real-time. In this regard, the vehicle occupant is afforded the benefit of an accurate and meaningful compilation of data in the form of advertisements.

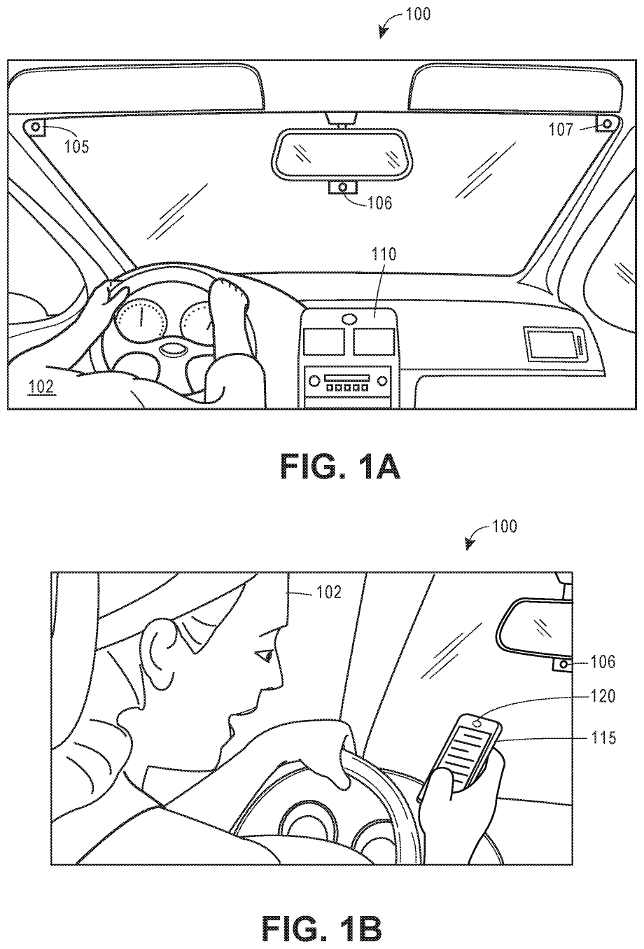

FIG. 1A illustrates an example depiction of an interior of a vehicle 100 that may include various components associated with the systems and methods. In some scenarios, an individual 102 may operate (i.e., drive) the vehicle 100. Although the individual 102 is depicted as sitting in the driver's seat of the vehicle 100 and operating the vehicle 100, it should be appreciated that the individual 102 may be a passenger of the vehicle, and may sit in a front passenger seat or any of a set of rear passenger seats. In scenarios in which the individual 102 is a passenger of the vehicle 100, another individual may operate the vehicle 100.

As depicted in FIG. 1A, the interior of the vehicle 100 may support a set of image sensors 105, 106, 107. In the particular scenario depicted in FIG. 1A, each of the image sensors 105, 107 is located near a top corner of the interior of the vehicle 100, and the image sensor 106 is located below a rear view mirror. Although three (3) image sensors are depicted in FIG. 1A, it should be appreciated that additional or fewer image sensors are envisioned. Further, it should be appreciated that the image sensors 105, 106, 107 may be disposed or located at various alternate or additional portions of the vehicle 100, including on an exterior of the vehicle 100.

Each of the image sensors 105, 106, 107 may be configured to detect and convey information that constitutes an image. In particular, each of the image sensors 105, 106, 107 may generate digital image data according to the detected information, where the digital image data may be in the form of image data and/or video data. Although not depicted in FIG. 1A, the vehicle 100 may also include one or more microphones that may be disposed in one or more locations, where the microphones may be configured to capture audio data that may supplement the digital image data captured by the image sensors 105, 106, 107.

The vehicle 100 may also be configured with an electronic device 110 configured with any combination of software and hardware components. In some implementations, the electronic device 110 may be included as part of an on-board diagnostic (OBD) system or any other type of system configured to be installed in the vehicle 100, such as an original equipment manufacturer (OEM) system. The electronic device 110 may include a set of sensors configured to detect and record various telematics data associated with the vehicle 100. In some implementations, the electronic device 110 may be configured to communicate with (i.e., request, retrieve, or receive data from) a set of sensors disposed in other locations of the vehicle 100, such as each of the image sensors 105, 106, 107. Further, in some implementations, the electronic device 110 itself may be equipped with one or more image sensors.

According to embodiments, the set of sensors included in the electronic device 110 or otherwise configured to communicate with the electronic device 110 may be of various types. For example, the set of sensors may include a location module (e.g., a global positioning system (GPS) chip), an accelerometer, an ignition sensor, a clock, speedometer, a torque sensor, a throttle position sensor, a compass, a yaw rate sensor, a tilt sensor, a steering angle sensor, a brake sensor, and/or other sensors. The set of sensors may also be configured to detect various conditions of the individual 102, including various biometric information, movements, and/or the like.

FIG. 1B depicts another configuration of an interior of the vehicle 100 that may include various components associated with the systems and methods. Similar to the depiction of FIG. 1A, the depiction of FIG. 1B illustrates the individual 102 who may be an operator or passenger of the vehicle. The individual 102 may access and interface with an electronic device 115 that may be located within the vehicle 100. Although FIG. 1B depicts the individual 102 holding the electronic device 115, it should be appreciated that the electronic device 115 may be located within the vehicle 100 without the individual 102 contacting the electronic device 115. For example, the electronic device 115 may be secured within a mount.

According to embodiments, the electronic device 115 may be any type of electronic device such as a mobile device (e.g., a smartphone). It should be appreciated that other types of electronic devices and/or mobile devices are envisioned, such as notebook computers, tablets, phablets, GPS (Global Positioning System) or GPS-enabled devices, smart watches, smart glasses, smart bracelets, wearable electronics, PDAs (personal digital assistants), pagers, computing devices configured for wireless communication, and/or the like. The electronic device 115 may be configured with at least one image sensor 120 configured to capture digital image data, as discussed herein. The electronic device 115 may further include additional sensors, such as a clock, accelerometer, location module (e.g., GPS chip), gyroscope, compass, biometric, and/or other types of sensors.

In some implementations, the electronic device 115 may be configured to interface with additional components of the vehicle 100. In particular, the electronic device 115 may interface with the electronic device 110 and sensors thereof, any of the image sensors 105, 106, 107, and/or other components of the vehicle 100, such as any additional sensors that may be disposed within the vehicle 100. Further, although not depicted in FIG. 1A or 1B, the vehicle 100 and/or each of the electronic devices 110, 115 may be equipped with storage or memory capable of storing various data.

In operation, either of the electronic devices 110, 115 may be configured to receive or otherwise access image data captured by any combination of the image sensors 105, 106, 107, 120. The electronic devices 110, 115 may access user profile data that may be stored in the storage or memory, and may compare the received image data to the user profile data to identify the individual 102 who may be depicted in the image data.

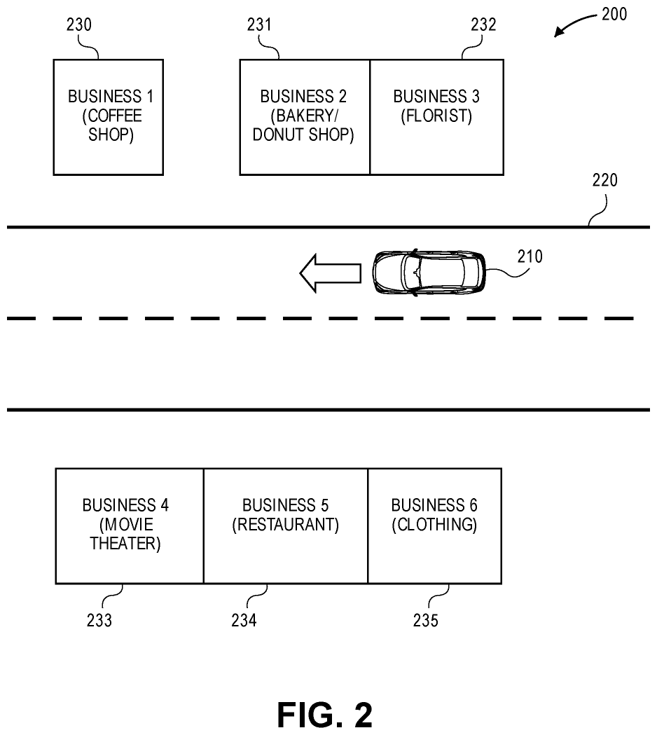

FIG. 2 illustrates an exemplary scenario 200 of a vehicle 210 operating on a street 220. According to the scenario 200, as the vehicle 210 travels down the street 220, the vehicle 210 passes by several businesses 230-235 on either side of the street 220 and in the immediate vicinity of the vehicle 210. The businesses 230-235 may vary in type. For example, there may be a coffee shop 230, bakery/donut shop 231, florist 232, movie theater 233, restaurant 234, and clothing store 235. It should be appreciated that other types of businesses are envisioned. Additionally, each of the businesses 230-235 may offer or otherwise avail its own set of advertisements. In particular, a respective set of advertisements for the respective businesses 230-235 may indicate a set of goods or services available for sale by the respective businesses 230-235.

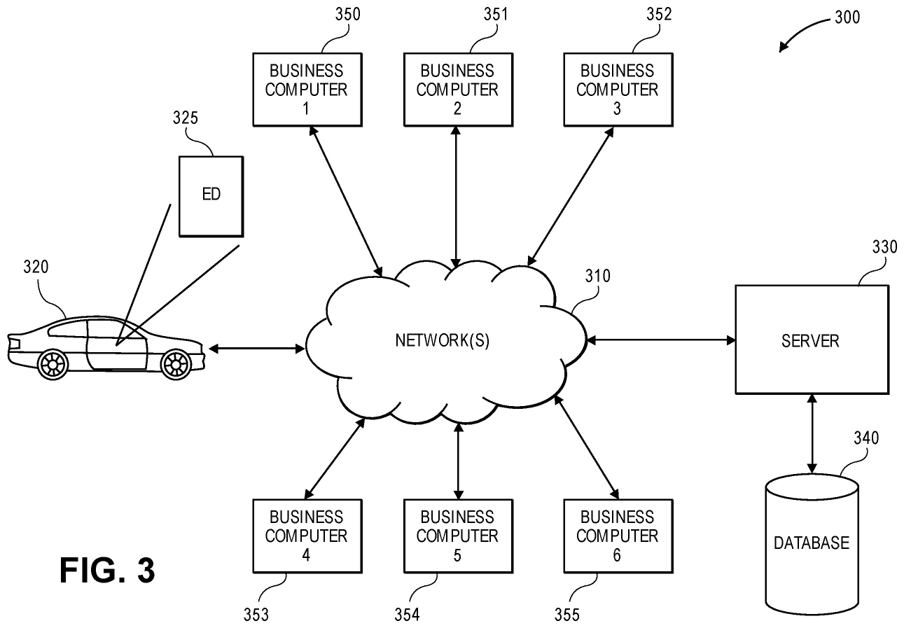

FIG. 3 illustrates an exemplary block diagram of an interconnected wireless communication system 300. The system 300 may include a network(s) 310. In certain embodiments, the network(s) 310 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). The network(s) 310 may also be one or more private or local networks or dedicated frequency bands.

As depicted in FIG. 3, the communication system 300 may include various components configured to communicate via and interface with the network(s) 310. In particular, a vehicle 320 may interface with the network(s) 310 via an electronic device 325 that may be located within the vehicle 320. According to embodiments, the electronic device 325 may be a mobile device (such as the electronic device 115 as discussed with respect to FIG. 1B). In other embodiments, the electronic device 325 may be an on-board vehicle computer (such as the electronic device 110, as discussed with respect to FIG. 1A).

A remote server 330 may also interface with the network(s) 310. In one embodiment, the remote server 330 may have access to a database 340. The database 340 may contain or store different kinds of information. In one implementation, the database 340 may contain or store information (e.g., address, phone number, hours of operation, etc.) about businesses that may be in proximity to the vehicle 320. The database 340 may also contain or store information about the advertisements that are currently offered by or valid for each business.

Additionally, each business (such as the businesses 230-235 as discussed with respect to FIG. 2) may have a computing device(s) 350-355 (hereinafter referred to as “business computer”) that may interface with the network(s) 310. The business computers 350-355 may transmit advertisement information (e.g., information about a sale(s), coupon(s), etc.) to the remote server 330 via the network(s) 310 to be stored in the database 340. Because businesses periodically change their advertisements, the business computers 350-355 may periodically update the advertisement information stored in the database 340 by transmitting updated advertisement information to the remote server 330 via the network(s) 310 to be stored in the database 340.

In embodiments, the electronic device 325 associated with the vehicle 320 may transmit location information via the network(s) 310 to the remote server 330. The remote server 330 may then determine which businesses (such as one or more of the businesses 230-235 discussed with respect to FIG. 2) may be in proximity to the electronic device 325 associated with the vehicle 320, and therefore in proximity to the vehicle 320 itself. After determining the businesses in proximity to the vehicle 320, the remote server 330 may access the database 340 in order to obtain advertisement data and/or other information about the businesses in proximity to the vehicle 320.

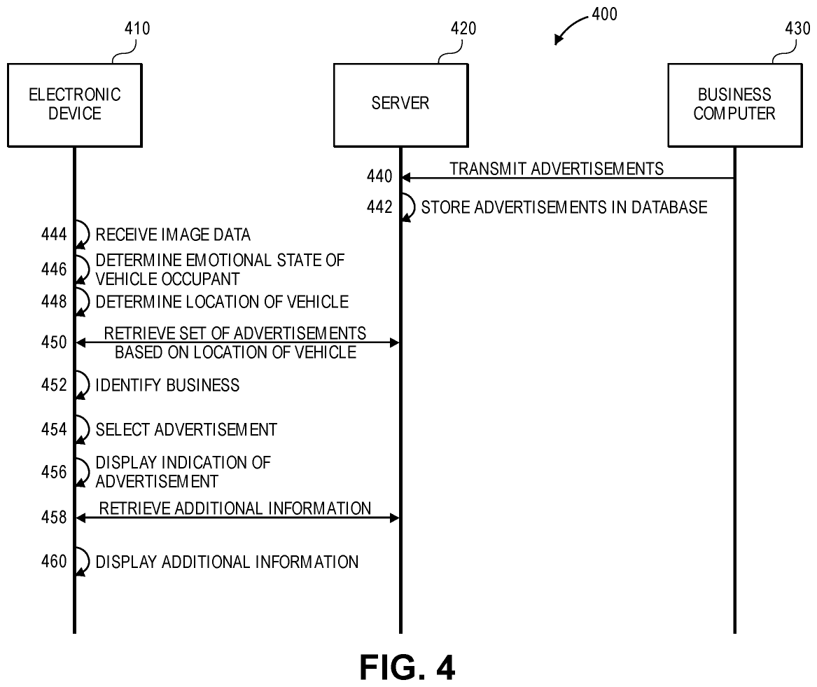

FIG. 4 depicts an exemplary signal diagram 400 associated with facilitating certain functionalities associated with the systems and methods. The signal diagram 400 includes a set of components that may be associated with improving a driving experience: an electronic device 410 (such as one of the electronic devices 110, 115 as discussed with respect to FIGS. 1A and 1B), a remote server 420 (such as the remote server 330 as discussed with respect to FIG. 3), and a business computer 430 (such as the business computers 350-355 as discussed with respect to FIG. 3). According to embodiments, the electronic device 410 may be associated with a vehicle and may be present within the vehicle during operation of the vehicle.

The signal diagram 400 may begin when the business computer 430 transmits (440) advertisement information to the remote server 420 via a network connection. The remote server may then store (442) the advertisement information in a database. The advertisement information may be periodically changed or updated in the same manner if the business modifies the advertisements that are currently available or provides new advertisements. Generally, an advertisement may be a communication (e.g., an electronic message) that employs a message to promote or sell a product, service, or idea that may be offered for sale by a business. Some examples of advertisements may be an offer for goods or services provided at a lower cost than usual (e.g., a sale), a certain percentage discounted from a purchase or a certain dollar amount discounted from a purchase, etc. Additionally, an advertisement may have an expiration date, may only be valid for a certain number of items or a certain amount of money, may only be valid at certain business locations, and/or may include other conditions.

The signal diagram 400 may continue when the electronic device 410 receives (444) image data depicting an occupant of the vehicle from at least one image sensor located within the vehicle. In embodiments, the at least one image sensor may be a component of or separate from the electronic device 410. The electronic device 410 may analyze the image data to determine (446) the emotional state of the vehicle occupant. To determine (446) the emotional state of the vehicle occupant, the electronic device 410 may identify, from the image data, characteristics indicative of one or more emotions being exhibited by the vehicle occupant. Based on the characteristics that are identified and their similarity (or dissimilarity) to the corresponding one or more emotions, the electronic device 410 may determine a percentage likelihood that the vehicle operator is expressing one or more specific emotions. For example, if the vehicle occupant is singing and moving along to the music playing inside the car, the electronic may determine that there is a 90% likelihood that the vehicle operator is in a happy emotional state. The electronic device 410 may also determine (448) a location of the vehicle (e.g., by using GPS). In particular, the electronic device 410 may identify its own location and may deem this location as the location of the vehicle.

In another embodiment, after receiving the image data, the electronic device 410 may transmit the image data to the remote server 420 via the network connection. The remote server 420 may then analyze the image data to determine the emotional state of the vehicle occupant, similar to the analysis performed by the electronic device 410 in (446). After the remote server 420 determines the emotional state of the vehicle occupant, the remote server 420 may then transmit an indication of the emotional state of the vehicle occupant to the electronic device 410 via the network connection.

The electronic device 410 may retrieve (450) a set of advertisements. In particular, the electronic device 410 may transmit the location of the vehicle to the remote server 420 via the network connection. Based on the location of the vehicle, the remote server 420 may determine a set of businesses in proximity to the vehicle. The set of businesses in proximity to the vehicle is determined by identifying businesses that are within a predetermined distance from the location of the vehicle. For example, if the predetermined distance from the location of the vehicle is one mile, then businesses (e.g., pharmacies, restaurants, retail stores, etc.) within one mile from the location of the vehicle may be identified to be included in the set of businesses. After the set of businesses is determined, the remote server 420 may access the database in order to retrieve a set of advertisements for each business in the set of businesses. The remote server 420 may transmit the set of advertisements to the electronic device 410 via the network connection.

After the electronic device 410 receives the set of advertisements, the electronic device 410 may identify (452) a specific business in the set of businesses and select (454) a specific advertisement from the set of advertisements for the identified business. The identification of the specific business and the selection of the specific advertisement by the electronic device 410 is based at least in part on one or more of the following: 1) the emotional state of the vehicle occupant determined in (446); 2) a set of preferences; 3) a time of day, day of week, or date; 4) a final destination of the vehicle; 5) historical behavior of the vehicle occupant (e.g., previous visits to the same fast food restaurant when the vehicle occupant is angry), and 6) recent visits to businesses by vehicle occupant (e.g., if the vehicle occupant visited the same fast food restaurant when he/she was happy for two days in a row, an advertisement for a different business may appear on the electronic device 410 on the third day when he/she is happy). According to embodiments, the set of preferences may be predefined by the vehicle occupant (e.g., likes, dislikes, hobbies, etc.), may contain factual information (e.g., gender, age, etc.), and/or may be stored on the electronic device.

The emotional state of the vehicle occupant may influence what type of business and advertisement may appeal to the vehicle occupant. For example, if the vehicle occupant is in a happy emotional state, an advertisement for a movie theater (e.g., discount on movie tickets, discount on popcorn, etc.) may be appealing to the vehicle occupant. In another example, if the vehicle occupant is in a sad or angry emotional state, an advertisement for food (e.g., bakery/donut shop, restaurant, etc.) may be appealing to the vehicle occupant. In an implementation, each advertisement may have an associated data value or “flag” that indicates a corresponding emotional state. The electronic device 410 may then match a determined emotional state of the vehicle occupant to an advertisement(s) associated with the same emotional state. For example, an advertisement for a coffee shop may have a data value indicating a drowsy emotional state.

Additionally or alternatively, the set of preferences, time of day, day of week, and date, and/or final destination of the vehicle may also be used to determine the business and advertisement that may be suited for the vehicle occupant. For example, if a preference indicates that the vehicle occupant likes nail polish, an advertisement for cosmetics may be relevant or desired. For further example, an advertisement for a coffee shop may be relevant in the morning, whereas an advertisement for a restaurant may be relevant in the evening. As an additional example, if the final destination of the vehicle occupant is the home of the vehicle occupant, then an advertisement for a fast food restaurant may be relevant as the vehicle occupant may want to pick up some food on the way home, whereas if the final destination for the vehicle occupant is work, then an advertisement for a coffee shop may be relevant as the vehicle occupant may want coffee to bring to work. Additionally, for example, if the date is Mother's Day, then an advertisement for a florist may be relevant to remind the vehicle occupant to buy his/her mother flowers, whereas if the date is Thanksgiving, advertisements for a grocery store may be relevant as the vehicle occupant may need to purchase food for Thanksgiving dinner.

After the electronic device 410 has identified a specific business and selected a specific advertisement from this business, the user interface of the electronic device 410 may display (456) an indication of the advertisement. In embodiments, the indication of the advertisement may contain a link to access additional information associated with the advertisement. In embodiments, the additional information may include an address of and directions to the business, business hours, and/or other information. If the electronic device detects that the vehicle occupant selects the link, the electronic device 410 may retrieve (458) the additional information from the remote server 420 via the network connection. The electronic device may then display (460) the additional information on the user interface of the electronic device 410.

In another embodiment, the electronic device 410 may not receive an indication for an advertisement directly at the user interface for the vehicle occupant to view. Instead, an email with an advertisement or a link to an advertisement may be sent to the vehicle occupant to be viewed at a later time. For example, a vehicle occupant may frequently pass by a specific donut shop when he/she is angry. Therefore, an email with a promotional coupon for the donut shop may be sent to the vehicle occupant after he/she passes by the donut shop so that the vehicle occupant can use the promotional coupon the next time he/she passes by the donut shop when angry.

Further, the electronic device 410 may determine an optimal time to display the advertisement or the email with the advertisement. The optimal time may be based upon a set of vehicle kinematics (i.e., the movement of the vehicle) or a current time. For example, the optimal time based upon a set of vehicle kinematics may be when the vehicle is not moving (e.g., when the vehicle and/or electronic device 410 accelerometer sensor data is zero) for a certain amount of time so as not to distract the vehicle occupant while he/she is inside the vehicle when it is moving. For another example, the optimal time based upon the current time may be an hour before the vehicle occupant leaves work to go home for the day because he/she will remember the advertisement when he/she passes by the business on the way home from work, and thus, may be more likely to make a purchase at the business.

In yet another embodiment, a hard copy of an advertisement may be mailed to the vehicle occupant. In still another embodiment, an advertisement may be presented to the vehicle occupant while he/she is streaming online video content when he/she is not in the vehicle.

In an implementation, the electronic device 410 may transmit an indication of the emotional state of the vehicle occupant to the remote server 420 via the network connection and the remote server 420 may identify a specific advertisement(s) based at least in part on the emotional state as well as on the location of the vehicle. The remote server 420 may then transmit the advertisement information to the electronic device via the network connection so that the user interface of the electronic device 410 may display 456 an indication of the advertisement.

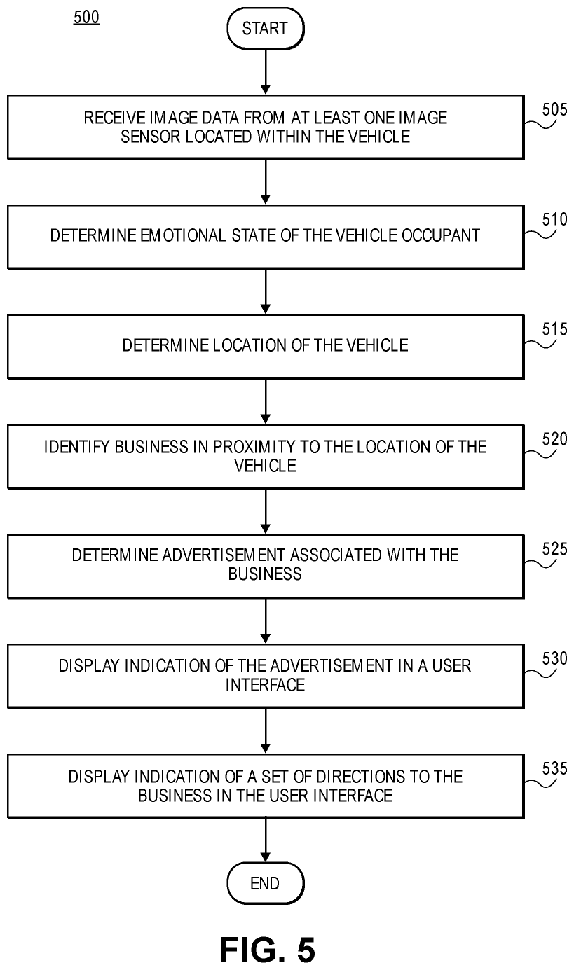

FIG. 5 depicts a block diagram of an exemplary method 500 of improving the driving experience. The method 500 may be facilitated by an electronic device that may be located within a vehicle or incorporated as part of the vehicle. The electronic device may support execution of a dedicated application that may facilitate the functionalities of the method 500. Further, the electronic device may enable the vehicle occupant to make various selections and facilitate various functionalities.

The method 500 may begin when the electronic device receives (block 505) image data from at least one image sensor located within the vehicle. In embodiments, the image sensor may be a component of the electronic device itself or may be external to the electronic device. Further, the image data may be received in real-time or near real-time as the at least one image sensor captures the image data.

After receiving the image data, the electronic device may determine (block 510), based on the image data, an emotional state of the vehicle occupant. In embodiments, the emotional state of the vehicle occupant may be inferred by the analysis of the image data to identify a set of elements and behaviors that may be exhibited by the vehicle occupant as depicted in the image data.

The electronic device may determine (block 515) the location of the vehicle. The location of the vehicle may be determined by the use of GPS software (e.g., a GPS application on a smartphone) on the electronic device. The electronic device may use the location of the vehicle to identify (block 520) a business in proximity to the location of the vehicle. In embodiments, the electronic device may determine the business based at least in part on the emotional state of the vehicle occupant. The electronic device may additionally or alternatively determine the business based at least in part on a set of preferences associated with the vehicle occupant and based on at least one of a time of day, day of week, and date. Additionally, the electronic device may determine the business based on the final destination of the vehicle. Further, the electronic device may interface with the remote server to determine the business, such as by sending and receiving relevant information from the remote server.

The electronic device may determine (block 525) an advertisement associated with the business. Once the advertisement is determined, the electronic device may determine an optimal time to display the advertisement in a user interface of the electronic device based upon a set of vehicle kinematics and/or a current time. The electronic device may display (block 530), at the optimal time, an indication of the advertisement in the user interface. The indication of the advertisement that is displayed on the electronic device may consist of a link to access additional information associated with the advertisement. If the additional information is accessed (i.e., the vehicle occupant selects the link), the electronic display may display (block 535) the additional information. For example, the additional information may include a set of directions to the business.

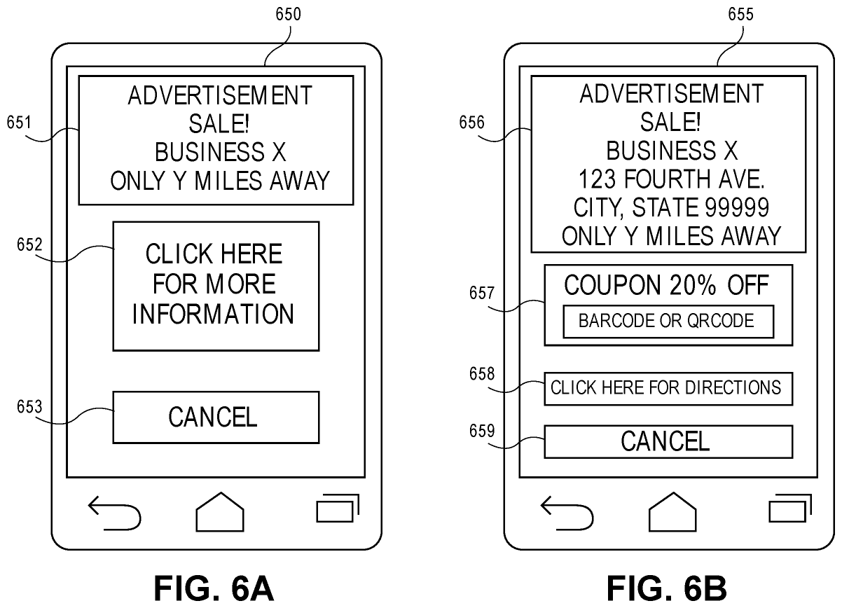

FIGS. 6A and 6B illustrate exemplary interfaces associated with improving the driving experience using detected or determined information about the location of the vehicle, vehicle occupant, and businesses in proximity to the vehicle. An electronic device (e.g., a mobile device, such as a smartphone) may be configured to display the interfaces and/or receive selections and inputs via the interfaces, where the electronic device may be associated with an occupant of a vehicle, or may be integrated into the vehicle. For example, a dedicated application that is configured to operate on the electronic device may display the interfaces. It should be appreciated that the interfaces are merely exemplary and that alternative or additional content is envisioned.

FIG. 6A illustrates an interface 650 associated with an advertisement for a business in proximity to the vehicle. The interface 650 may include an information box 651 that identifies the advertisement for the business and the distance the business is away from the vehicle. The interface 650 may include a “CLICK HERE FOR MORE INFORMATION” selection 652 that enables an accessing user to select to proceed to a subsequent interface that provides more information about the business and the advertisement for the business. The interface 650 may also include a “CANCEL” selection 653 that enables an accessing user to select to dismiss the interface 650.

FIG. 6B illustrates an additional interface 655 associated with the advertisement for the business in proximity to the vehicle. In some embodiments, the electronic device may display the additional interface 655 in response to the user selecting the “CLICK HERE FOR MORE INFORMATION” selection 652. The interface 655 may include an information box 656 that identifies the advertisement for the business, the address of the business, and the distance the business is away from the vehicle. The interface 655 may also include a second information box 657 that identifies a coupon for the business. The information box 657 may also include a bar code or a QR code for the coupon. Additionally, the interface 655 may include a “CLICK HERE FOR DIRECTIONS” selection 658 that enables the accessing user to select to proceed to a subsequent interface that provides directions (e.g., GPS navigation) to the business. Further, the interface 655 may also include a “CANCEL” selection 659 that enables an accessing user to select to dismiss the interface 655.

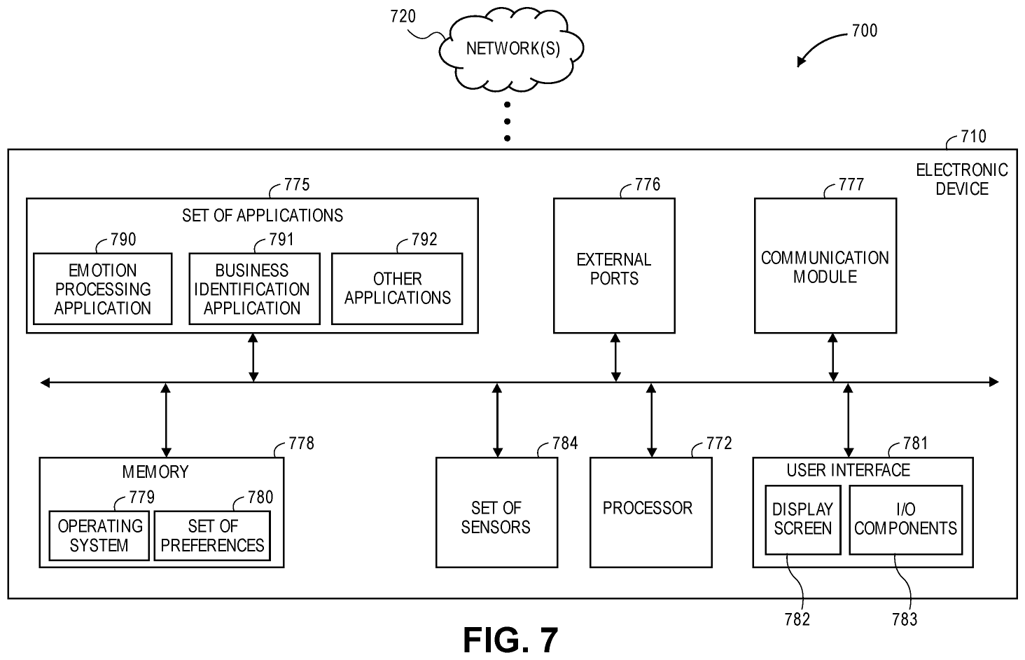

FIG. 7 illustrates a diagram of an exemplary mobile or other electronic device 710 (such as one of the electronic devices 110, 115 as discussed with respect to FIG. 1) in which the functionalities as discussed herein may be implemented. It should be appreciated that the electronic device 710 may be configured to be transported in a vehicle and/or connect to an on-board telematics platform of the vehicle, as discussed herein. Further, it should be appreciated that the electronic device 710 may be integrated into an on-board system of the vehicle. In some implementations, the electronic device 710 may be included as part of a remote server (such as the remote server 330 and 420 as discussed with respect to FIGS. 3 and 4 respectively).

The electronic device 710 may include a processor 772 as well as a memory 778. The memory 778 may store an operating system 779 capable of facilitating the functionalities as discussed herein as well as a set of applications 775 (i.e., machine readable instructions). For example, one of the set of applications 775 may be an emotion processing application 790 configured to analyze image data to identify characteristics (e.g., movements, expressions, etc.) of the vehicle occupant depicted in the image data in order to determine the emotional state of the vehicle occupant. Another example of one of the set of applications 775 may be a business identification application 791 configured to identify which business to select an advertisement from based on the analysis of the emotion processing application 790. It should be appreciated that one or more other applications 792 are envisioned.

The processor 772 may interface with the memory 778 to execute the operating system 779 and the set of applications 775. According to some embodiments, the memory 778 may also include a set of preferences 780 of the vehicle occupant such as likes, dislikes, hobbies, gender, age, etc. In some implementations, the business identification application 791 may interface with the set of preferences 780 and the emotion processing application 790 in order to identify the business to advertise to the vehicle occupant. The memory 778 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 710 may further include a communication module 777 configured to communicate data via one or more networks 720. According to some embodiments, the communication module 777 may include one or more transceivers (e.g., WWAN, WLAN, and/or WPAN transceivers) functioning in accordance with IEEE standards, 3GPP standards, or other standards, and configured to receive and transmit data via one or more external ports 776. Further, the communication module 777 may include a short-range network component (e.g., an RFID reader) configured for short-range network communications. For example, the communication module 777 may receive, via the network 720, image data from a set of image sensors. For further example, the communication module 777 may transmit data to and receive data from a remote server via the network 720.

The electronic device 710 may further include a set of sensors 784. The processor 722 and the set of applications 775 may interface with the set of sensors 784 to retrieve and process the corresponding sensor data. In one particular implementation, the emotion processing application 790 may use various data from the set of sensors to determine the emotional state of the vehicle occupant. Further, in an implementation, the electronic device 710 may interface with one or more image sensors that may be external to the electronic device 710.

The electronic device 710 may further include a user interface 781 configured to present information to a user and/or receive inputs from the user. As shown in FIG. 7, the user interface 781 may include a display screen 782 and I/O components 783 (e.g., ports, capacitive or resistive touch sensitive input panels, keys, buttons, lights, LEDs, speakers, microphones). According to some embodiments, the user may access the electronic device 710 via the user interface 781 to review information and/or perform other functions. In some embodiments, the electronic device 710 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 772 (e.g., working in connection with the operating system 779) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

Although the following texts set forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A computer-implemented method in an electronic device for displaying advertising content to an occupant of a vehicle, the electronic device located within the vehicle, the method comprising:
receiving image data from at least one image sensor located within the vehicle, the image data depicting the vehicle occupant;
determining, based on the image data, an emotional state of the vehicle occupant;
determining (i) a location of the vehicle, (ii) a current time of day, and (iii) a final destination of the vehicle occupant;
identifying, based at least in part on (i) the emotional state of the vehicle occupant determined based on the image data, (ii) the current time of day, and (iii) the final destination of the vehicle occupant, a business within a predetermined distance from the location of the vehicle;
determining, based on the emotional state of the vehicle occupant determined based on the image data, an advertisement associated with the business;
determining, based on a set of vehicle kinematics data, that the vehicle is not moving for a certain amount of time;
in response to determining that the vehicle is not moving for the certain amount of time, concurrently displaying, in a user interface of the electronic device, (i) the advertisement, (ii) a bar code or a QR code of a coupon associated with the business, and (iii) a link to access additional information associated with the business;
receiving, via the user interface, a selection of the link to access the additional information associated with the business;
retrieving, from a remote server, the additional information; and
in response to retrieving the additional information, displaying the additional information in the user interface, the additional information comprising a set of directions to the business and business hours for the business.

2. The computer-implemented method of claim 1, wherein identifying the business comprises:
retrieving, from the remote server, a set of indications of a set of businesses within the predetermined distance from the location of the vehicle; and
identifying the business from the set of businesses.

3. (canceled)

4. The computer-implemented method of claim 1, wherein identifying the business comprises:
accessing a set of preferences associated with the occupant of the vehicle; and
determining, further based at least in part on the set of preferences, the business within the predetermined distance from the location of the vehicle.

5. The computer-implemented method of claim 1, wherein identifying the business comprises:
determining, further based on at least one of a day of week or a date, the business within the predetermined distance from the location of the vehicle.

6. (canceled)

7. The computer-implemented method of claim 1, wherein determining the advertisement associated with the business comprises:
retrieving, from the remote server, a set of advertisements associated with the business; and
selecting, based on the emotional state of the vehicle occupant, the advertisement from the set of advertisements.

8. The computer-implemented method of claim 1, further comprising:
retrieving the advertisement from the remote server.

9. (canceled)

10. (canceled)

11. (canceled)

12. A system for displaying advertising content to an occupant of a vehicle, comprising:
an image sensor located within the vehicle;
a user interface located within the vehicle;
a memory configured to store non-transitory computer executable instructions; and
a processor interfacing with the image sensor, the user interface, and the memory, wherein the processor is configured to execute the non-transitory computer executable instructions to cause the processor to:
receive image data from at least one image sensor located within the vehicle, the image data depicting the vehicle occupant,
determine, based on the image data, an emotional state of the vehicle occupant,
determine (i) a location of the vehicle, (ii) a current time of day, and (iii) a final destination of the vehicle occupant,
identify, based at least in part on (i) the emotional state of the vehicle occupant determined based on the image data, (ii) the current time of day, and (iii) the final destination of the vehicle occupant, a business within a predetermined distance from the location of the vehicle,
determine, based on the emotional state of the vehicle occupant determined based on the image data, an advertisement associated with the business,
determine, based on a set of vehicle kinematics data, that the vehicle is not moving for a certain amount of time,
in response to determining that the vehicle is not moving for the certain amount of time, cause the user interface to concurrently display (i) the advertisement, (ii) a bar code or a QR code of a coupon associated with the business, and (iii) a link to access additional information associated with the business,
receive, via the user interface, a selection of the link to access the additional information associated with the business,
retrieve, from a remote server, the additional information, and
in response to retrieving the additional information, cause the user interface to display the additional information in the user interface, the additional information comprising a set of directions to the business and business hours for the business.

13. The system of claim 12, wherein to identify the business, the processor is configured to:
retrieve, from the remote server, a set of indications of a set of businesses within the predetermined distance from the location of the vehicle; and
identify the business from the set of businesses.

14. (canceled)

15. The system of claim 12, wherein to identify the business, the processor is configured to:
access a set of preferences associated with the occupant of the vehicle; and
determine, further based at least in part on the set of preferences, the business within the predetermined distance from the location of the vehicle.

16. The system of claim 12, wherein to identify the business, the processor is configured to:
determine, further based on at least one of a day of week or a date, the business within the predetermined distance from the location of the vehicle.

17. (canceled)

18. The system of claim 12, wherein to determine the advertisement associated with the business, processor is further configured to:
retrieve, from the remote server, a set of advertisements associated with the business; and
select, based on the emotional state of the vehicle occupant, the advertisement from the set of advertisements.

19. The system of claim 12, wherein the processor is further configured to:
retrieve the advertisement from the remote server.

20. (canceled)

21. (canceled)

22. (canceled)
